(19) United States
(12) Patent Application Publication
(10) Pub. No.: US 2026/0350652 A1
(43) Pub. Date: Nov. 5, 2026

(54) SYSTEMS AND METHODS FOR SELECTING TEMPLATES FOR DISPLAYING PRODUCT RELATED CONTENT ON ELECTRONIC DISPLAY DEVICES

(71) Applicant: VUSIONGROUP GMBH, Fernitz-Mellach (AT)

(72) Inventors: Matthias BUCH, Fernitz-Mellach (AT); Scott SOONG, Fernitz-Mellach (AT)

(73) Assignee: VUSIONGROUP GMBH, Fernitz-Mellach (AT)

(21) Appl. No.: 19/487,430

(22) PCT Filed: Jun. 1, 2023
(86) PCT No.: PCT/EP2023/064753

§ 371 Date: Nov. 24, 2025

(51) Int. Cl. G06Q 30/0251

(52) U.S. Cl. CPC G06Q 30/0261

(57) ABSTRACT

There is disclosed a system for selecting a template for displaying content on electronic display devices associated with a product for sale, the content relating to the product for sale. The system comprises a template generating unit (110) configured to generate a first and a second template; a first electronic display device (121), the first electronic display device being arranged at a first location (A) and configured to display the content utilizing the first template; a second electronic display device (122), the second electronic display device being arranged at a second location (B) and configured to display the content utilizing the second template; a first monitoring arrangement (131), the first monitoring arrangement being configured to monitor customer attention to and/or sales of the product at the first location and to provide corresponding first monitoring data; a second monitoring arrangement (132), the second monitoring arrangement being configured to monitor customer attention to and/or sales of the product at the second location and to provide corresponding second monitoring data; and a selection unit (140) configured to apply statistical processing to the first monitoring data and the second monitoring data, and to select one of the first and second templates based on the statistical processing. Furthermore, a method is disclosed.

### TECHNICAL FIELD

The present disclosure relates to the field of electronic shelf labeling, in particular to a system and a method for selecting templates for displaying product related content on electronic shelf labels.

### BACKGROUND

The use of electronic shelf label (ESL) systems in stores and showrooms for displaying relevant content relating to the products offered for sale is continuously growing. Such systems are appreciated for providing numerous benefits and simplifications for store management teams. In particular, the manual labor associated with placing and updating conventional shelf labels can be significantly reduced by defining the content to be displayed on each ESL device via a central computer-based management system. In other words, the responsible employee does not need to visit each and every shelf in the store to place or substitute a paper label.

Modern ESL systems allow an increasing number of options with regard to designing the physical appearance of the devices, in particular with regard to graphic design and use of colors. These options can be useful in marketing strategies, as some designs appeal more to customers than others. However, these effects depend on many factors, including e.g., product categories, cultural and geographic aspects, and it is thus a complex task to identify the best or most efficient designs to use in any given situation.

There may thus be a need for improved ESL systems capable of evaluating various designs for presenting information to potential buying customers.

This as well as other needs may be met by the subject matter of the appended independent claims. Further advantageous features are set forth in the dependent claims.

### SUMMARY

According to a first aspect of the present disclosure, a system for selecting a template for displaying content on electronic display devices associated with a product for sale is provided, the content relating to the product for sale. The system comprises (a) a template generating unit configured to generate a first and a second template; (b) a first electronic display device, the first electronic display device being arranged at a first location and configured to display the content utilizing the first template; (c) a second electronic display device, the second electronic display device being arranged at a second location and configured to display the content utilizing the second template; (d) a first monitoring arrangement, the first monitoring arrangement being configured to monitor customer attention to and/or sales of the product at the first location and to provide corresponding first monitoring data; (e) a second monitoring arrangement, the second monitoring arrangement being configured to monitor customer attention to and/or sales of the product at the second location and to provide corresponding second monitoring data; and (f) a selection unit configured to apply statistical processing to the first monitoring data and the second monitoring data, and to select one of the first and second templates based on the statistical processing.

The first aspect is based on the idea that two different (first and second) templates are generated and used to display product relevant content (such as product-and/or price-information or background information or advertisement) on two different (first and second) electronic display devices (such as electronic shelf labels, abbreviated ESLs, which are installed at shelf rails at the front edge of shelf floors; such as vide rails which are installed at the front edge of a shelf floor) at different (first and second) locations, e.g., in two different stores or two different departments within one store. Two monitoring arrangements, a first monitoring arrangement at the first location and a second monitoring arrangement at the second location, are configured to monitor customer attention to and/or sales of the product at the two locations and provide corresponding first and second monitoring data. The (first and second) monitoring data is statistically processed by a selection unit which is further configured to select one of the two templates based on said statistical processing. In other words, the selection of one of the two templates is based on collected information as to their respective effect on customer attention and/or product sales. Thus, from a marketing perspective, the selected template may be the “best” template.

In the context of the present disclosure, the term “template” may in particular denote a graphical template defining a certain layout, such as one or more fields of specific size, text font, size and color, etc.

In the context of the present disclosure, the term “content” may in particular denote any form of content suitable for being displayed by an electronic display device, in particular in the form of image(s) and/or video(s) and/or text suitable for conveying relevant information on the associated product to a viewer or observer, e.g., a potential buyer. The information conveyed may in particular be any kind of product relevant data, such as pricing information (including various discount options), or product characteristics (e.g., dimensions and/or weight, and/or compatibility with other products, etc.).

The template generating unit may be a software application that allows a user to design and define templates.

The first electronic display device may be an ESL (electronic shelf label) capable of using a template to display content. The ESL may be a member of a group of ESLs installed in a store and connected to a corresponding controller, preferably via a wireless network connection, such as a Wi-Fi network, Bluetooth network, ZigBee network, or any proprietary radio network used in the retail environment. The same applies to the second electronic display device.

The electronic display devices may be installed in shelves, racks, or other similar arrangements within a building, such as a store, warehouse, showroom, etc. such that an interested person readily understands that the displayed content relates to a product (or product range) in the vicinity of the electronic display device.

The first and second monitoring arrangements are installed relative to the respective first and second ESL in order to provide the respective first and second monitoring data.

The selection unit may be a functional unit implemented on the same hardware as the template generating unit. Alternatively, the selection unit may be implemented on separate hardware in communication with the template generating unit. In both cases, the selection unit is capable of receiving the first and second monitoring data from the corresponding monitoring arrangements.

According to an exemplary embodiment, the first monitoring arrangement comprises a first video camera arranged to capture video of the first electronic display device and its surroundings, and a first video processing device configured to receive and process the video from the first video camera, the first video processing device further configured to determine a number of potential customers that pay attention to the first electronic display device and/or an amount of time that potential customers pay attention to the first electronic display device. Similarly, the second monitoring arrangement may comprise a second video camera arranged to capture video of the second electronic display device and its surroundings, and a second video processing device configured to receive and process the video from the second video camera, the second video processing device further configured to determine a number of potential customers that pay attention to the second electronic display device and/or an amount of time that potential customers pay attention to the second electronic display device.

In other words, in this exemplary embodiment video footage is used to determine how many potential customers pay interest to the respective ESLs and/or for how long.

According to a further exemplary embodiment, the first monitoring arrangement comprises a first sales monitoring unit coupled to a sales system at the first location and configured to determine the number of products sold and/or the sales figures or turnover of products at the first location. Furthermore, the second monitoring arrangement may comprise a second sales monitoring unit coupled to a sales system at the second location and configured to determine the number of products sold and/or the sales figures or turnover of products at the second location.

In this exemplary embodiment, sales data relating to the product is obtained at the first and second locations, e.g., in a first store and in a second store.

According to a further exemplary embodiment, the first monitoring arrangement comprises a first sensor configured to detect the presence of a customer within a predetermined first region in the vicinity of the first electronic display device. Furthermore, the second monitoring arrangement may comprise a second sensor configured to detect the presence of a customer within a predetermined second region in the vicinity of the second electronic display device.

In other words, first and second sensors are used to determine whether potential customers pay attention to the respective ESLs.

According to a further exemplary embodiment, the first sensor comprises one or more sensors selected from the group consisting of an infrared sensor, a subsonic sensor, an ultrasound sensor, a radar sensor, and a motion sensor. Similarly, the second sensor may comprise one or more sensors selected from the group consisting of an infrared sensor, a subsonic sensor, an ultrasound sensor, a radar sensor, and a motion sensor.

The first sensor may be integrated in the first ESL or in a frame or rack holding the first ESL. Similarly, the second sensor may be integrated in the second ESL or in a frame or rack holding the second ESL.

According to a further exemplary embodiment, the first monitoring data comprises one or more of a total number of customers that pay attention to the first electronic display device, an amount of time that potential customers pay attention to the first electronic display device, the total number of products sold and/or the sales figures or turnover of products at the first location. Similarly, the second monitoring data may comprise one or more of a total number of customers that pay attention to the second electronic display device, an amount of time that potential customers pay attention to the second electronic display device, the total number of products sold and/or the sales figures or turnover of products at the second location.

In other words, the first and second monitoring data are respectively indicative of how attractive the respective (first and second) template is found by potential customers at the first and second location, respectively.

According to a further exemplary embodiment, the selection unit is configured to apply the statistical processing to a part of the first monitoring data and to a part of the second monitoring data that are representative of a predetermined period of time.

The predetermined period of time may be less than an hour, an hour or a few hours, one or more days, a week, a month, or more.

According to a further exemplary embodiment, the first electronic display device is part of a first group of electronic display devices connected to a first controller at the first location, and the second electronic display device is part of a second group of electronic display devices connected to a second controller at the second location.

In other words, the first electronic display device is part of a first ESL system at the first location, and the second electronic display device is part of a second ESL system at the second location. Each of these (first and second) ESL systems have their respective (first and second) controllers allowing an operator to define the contents to be displayed on each ESL of the respective system.

According to a further exemplary embodiment, the first controller, the second controller, the template generating unit, and the selection unit are interconnected through a communication network, such as the Internet.

According to a further exemplary embodiment, the system further comprises a server, said server comprising the template generating unit and the selection unit.

The server may be located at the first location, at the second location, or at a further location, such as a central administrative office of a chain of stores.

According to a further exemplary embodiment, the selection unit is configured to, based on the statistical processing, automatically select the one of the first template and the second template that provide the better performance in terms of sales and/or customer attention.

In other words, the selection unit performs the selection of the best template automatically, i.e., without manual interaction and/or review by an operator.

According to a further exemplary embodiment, the first electronic display device and the second electronic display device are configured to apply the one of the first template and second template that is selected by the selection unit.

Thus, once the best template has been selected, both ESLs are set to use it.

According to a further exemplary embodiment, the template generating unit is further configured to generate a third and a fourth template, and the system further comprises (a) a third electronic display device, the third electronic display device being arranged at a third location and configured to display the content utilizing the third template; (b) a fourth electronic display device, the fourth electronic display device being arranged at a fourth location and configured to display the content utilizing the fourth template; (c) a third monitoring arrangement, the third monitoring arrangement being configured to monitor customer attention to and/or sales of the product at the third location and to provide corresponding third monitoring data; (d) a fourth monitoring arrangement, the fourth monitoring arrangement being configured to monitor customer attention to and/or sales of the product at the fourth location and to provide corresponding fourth monitoring data. The selection unit is configured to apply statistical processing to the third monitoring data and the fourth monitoring data, and to further select one of the third and fourth templates based on the statistical processing. The first and second locations are located in a first region and the third and fourth locations are located in a second region.

In short, this exemplary embodiment addresses the situation where customer behavior in remote regions, such as in different countries or on different continents, is expected to differ. By selecting one best template for the first region and another (possibly different) template for the second region, such differences in customer behavior can be taken into account.

According to a second aspect of the present disclosure, a method of selecting a template for displaying content on electronic display devices associated with a product for sale is provided, the content relating to the product for sale. The method comprises (a) generating a first and a second template; (b) displaying the content on a first electronic display device arranged at a first location, the first electronic display device utilizing the first template; (c) displaying the content on a second electronic display device arranged at a second location, the second electronic display device utilizing the second template; (d) obtaining first monitoring data by monitoring customer attention to and/or sale of the product at the first location; (e) obtaining second monitoring data by monitoring customer attention to and/or sale of the product at the second location; and (f) selecting one of the first and second templates based on statistical processing of the first monitoring data and the second monitoring data.

The second aspect is based on essentially the same idea as the first aspect. More specifically, first and second templates are generated and product relevant content is displayed on a first and a second electronic display device or ESL using respectively the first and second template. First and second monitoring data is obtained, and one of the two templates is selected on the basis of statistical processing of the first and second monitoring data. In other words, the selection of one of the two templates is based on collected information as to their respective effect on customer attention and/or product sales. Thus, from a marketing perspective, the selected template may be the “best” template.

According to a further exemplary embodiment, the first monitoring data comprises one or more of a total number of customers that pay attention to the first electronic display device, an amount of time that potential customers pay attention to the first electronic display device, the total number of products sold at the first location, and/or sales figures or turnover of products at the first location, and/or the second monitoring data comprises one or more of: a total number of customers that pay attention to the second electronic display device, an amount of time that potential customers pay attention to the second electronic display device, the total number of products sold at the second location, and/or the sales figures or turnover of products at the second location.

In other words, the first and second monitoring data are respectively indicative of how attractive the respective (first and second) template is found by potential customers at the first and second location, respectively.

According to a further exemplary embodiment, the statistical processing is applied to a part of the first monitoring data and to a part of the second monitoring data that are representative of a predetermined period of time.

Like above, the predetermined period of time may be less than an hour, an hour or a few hours, one or more days, a week, a month, or more.

According to a further exemplary embodiment, selecting one of the first and second templates comprises automatically selecting the one of the first template and the second template that provide the better performance in terms of sales and/or customer attention.

In other words, the selection of the best template is done automatically, i.e., without manual interaction and/or review by an operator.

According to a further exemplary embodiment, the method further comprises (a) generating a third template and a fourth template; (b) displaying the content on a third electronic display device arranged at a third location, the third electronic display device utilizing the third template; (c) displaying the content on a fourth electronic display device arranged at a fourth location, the fourth electronic display device utilizing the fourth template; (d) obtaining third monitoring data by monitoring customer attention to and/or sale of the product at the third location; (e) obtaining fourth monitoring data by monitoring customer attention to and/or sale of the product at the fourth location; and (f) selecting one of the third and fourth templates based on statistical processing of the third monitoring data and the fourth monitoring data, wherein the first and second locations are located in a first region and the third and fourth locations are located in a second region.

As above, this exemplary embodiment addresses the situation where customer behavior in remote regions, such as in different countries or on different continents, is expected to differ. By selecting one best template for the first region and another (possibly different) template for the second region, such differences in customer behavior can be taken into account.

The electronics of the various devices of the system, just like also the interface etc. thereof can be realized with the aid of a very wide range of passive and also active electronic components in a discrete and also integrated manner. Preferably, a microprocessor with corresponding peripheral components or a microcontroller, upon which a software for providing the various functionalities is executed, is used in this case. Also, what are known as ASICs (Application-Specific Integrated Circuits) can be used.

These and further aspects of the invention result from the figures discussed below.

### BRIEF DESCRIPTION OF THE DRAWINGS

FIG. 1 shows a system according to an exemplary embodiment.

FIG. 2 shows a block diagram of an ESL according to an exemplary embodiment.

FIG. 3 shows a flow chart of a method according to an exemplary embodiment.

### DETAILED DESCRIPTION

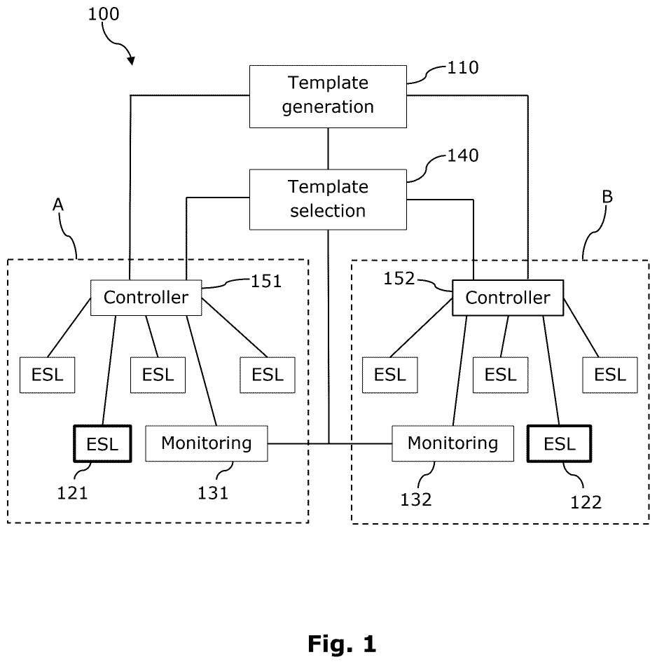

FIG. 1 shows a system 100 according to an exemplary embodiment. The system 100 comprises a template generating unit 110, a first electronic display device or ESL (electronic shelf label) 121 arranged at a first location A, a second electronic display device or ESL 122 arranged at a second location B, a first monitoring arrangement 131, a second monitoring arrangement 132, and a selection unit 140. The first ESL 121 is part of an ESL system at location A, e.g., a first store, and is like other ESLs in the system in network communication, preferably via Bluetooth ® (reference is made in particular to the “Bluetooth Core Specification”, Version v5.1, Version Date 2023-Jan.-23, in connection with the “Electronic Shelf Label Profile Specification”, Version V1.0, Version date 2023-Mar.-28, or higher; both are available at the website https://www.bluetooth.com; © Bluetooth SIG, Inc.), with a first controller 151. Similarly, the second ESL 122 is part of an ESL system at location B, e.g., a second store, and it is like other ESLs in the system in network communication, again preferably via Bluetooth ® as explained before, with a second controller 152. The template generating unit 110 and the selecting unit 140 may be different devices or integrated in one device, such as a server connected to the Internet.

The template generation unit 110 is configured to generate a first and a second template for displaying content relating to a product for sale on electronic display devices or ESLs (electronic shelf labels) associated with the product, for example the ESLs at the first location A and second location B, and at any further locations (not shown). More specifically, the template generation unit 110 may be a software application allowing a user to design a template, i.e., a layout including graphics, color, text fonts and size, etc. for displaying product related content, including pricing, features, and other relevant information to potential customers, on ESLs associated with the product, e.g., at respective shelves in the stores A and/or B. Hence, the template generation unit 110 allows for designing two different templates for the same product and to transmit corresponding data to the first and second ESLs 121, 122, respectively, via the corresponding controller 151, 152, such that the first ESL 121 uses the first template to display the product related content, and the second ESL 122 uses the second template to display the product related content. Thereby, the product related content will appear in accordance with the first template at location A and in accordance with the second template at location B.

The first monitoring arrangement 131 is configured to monitor customer attention to and/or sales of the product at the first location A and to provide corresponding first monitoring data to the selection unit 140, via a direct connection between the first monitoring arrangement 131 and the selection unit 140 and/or via the first controller 121. The first monitoring arrangement 131 may involve one or more sensors (not shown) located in the vicinity of the first ESL 121 and/or as integrated parts of the first ESL 121. For example, the first monitoring arrangement 131 may comprise one or more video cameras arranged to capture video of the first ESL 121 and its surroundings, and a video processing device capable of determining a number of potential customers that pay attention to the first electronic display device 121 and/or an amount of time that potential customers pay attention to the first electronic display device 121 as part of the first monitoring data. Furthermore, the first monitoring arrangement 131 may comprise an acoustic sensor, such as subsonic sensor or an ultrasonic sensor, an optical sensor, such as an infrared sensor, or a motion sensor. These sensors may be integrated within the first ESL 121 or in a frame or support structure holding the first ESL 121, such that the presence of potential customers in the immediate vicinity of the first ESL 121 can be registered and added to the first monitoring data. Additionally, or alternatively, the first monitoring arrangement 131 comprises a sales monitoring unit that is configured to obtain product specific sales data from the sales system of the store A. In other words, the first monitoring data may include data indicating the number of products sold and/or the sales figures or turnover of products at the first location A.

The second monitoring arrangement 132 is similar to the first monitoring arrangement 131 described above. That is, the second monitoring arrangement 132 is configured to monitor customer attention to and/or sales of the product at the second location B and to provide corresponding second monitoring data to the selection unit 140, via a direct connection between the second monitoring arrangement 132 and the selection unit 140 and/or via the second controller 122. The second monitoring arrangement 132 may involve one or more sensors (not shown) located in the vicinity of the second ESL 122 and/or as integrated parts of the second ESL 122. For example, the second monitoring arrangement 132 may comprise one or more video cameras arranged to capture video of the second ESL 122 and its surroundings, and a video processing device capable of determining a number of potential customers that pay attention to the second electronic display device 122 and/or an amount of time that potential customers pay attention to the second electronic display device 122 as part of the second monitoring data. Furthermore, the second monitoring arrangement 132 may comprise an acoustic sensor, such as subsonic sensor or an ultrasonic sensor, an optical sensor, such as an infrared sensor, or a motion sensor. These sensors may be integrated within the second ESL 122 or in a frame or support structure holding the second ESL 122, such that the presence of potential customers in the immediate vicinity of the second ESL 122 can be registered and added to the second monitoring data. Additionally, or alternatively, the second monitoring arrangement 132 comprises a sales monitoring unit (not shown) that is configured to obtain product specific sales data from the sales system of the store B. In other words, the second monitoring data may include data indicating the number of products sold and/or the sales figures or turnover of products at the second location B.

Summarizing, the first monitoring data may comprise one or more of a total number of customers that pay attention to the first electronic display device 121, an amount of time that potential customers pay attention to the first electronic display device 121, the total number of products sold and/or the sales figures or turnover of products at the first location A. Similarly, the second monitoring data may comprise one or more of a total number of customers that pay attention to the second electronic display device 122, an amount of time that potential customers pay attention to the second electronic display device 122, the total number of products sold and/or the sales figures or turnover of products at the second location B.

The selection unit 140 receives the first and second monitoring data from the first and second monitoring arrangements 131, 132, either continuously, in blocks (e.g., daily, weekly, or monthly blocks), or as complete data sets at the end of the template survey and monitoring process. The selection unit 140 is configured to apply statistical processing to the first and second monitoring data, and to select one of the first and second templates based on the statistical processing. That is, the selection unit 140 evaluates how much attention the two different templates have received and/or how much sale they have generated in the respective locations A and B. The statistical processing may take differences in size, number of customers, and other relevant parameters between the stores A and B into account. As a result of the statistical processing, the selection unit 140 selects the one of the first and second templates that have performed better. Moving forward, the selected template may then be used at both locations A and B while the other template is discarded.

The system 100 may of course be extended to test more than two templates at more than two locations/stores. Furthermore, the locations may be assigned to different regions, such as different countries or continents. That is, first and second templates may be tested at two locations in region 1 (e.g., Europe) and third and fourth templates may be tested at two locations in region 2 (e.g., Asia) to find the best template for each region. It should be noted that the first and second template may respectively be identical or similar to the third and fourth template. Alternatively, the first and second templates may be different from the third and fourth templates.

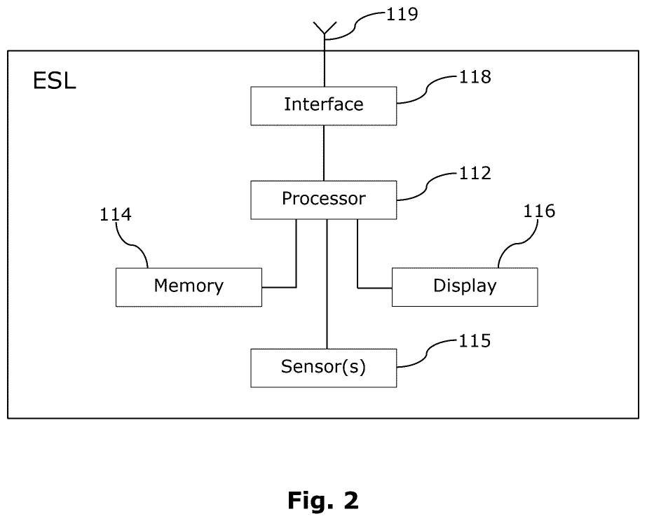

FIG. 2 shows a block diagram of an electronic display device ESL according to an exemplary embodiment. The ESL comprises a processor 112, a memory 114, one or more sensors 115, a display 116, an interface 118, and an antenna 119. The processor 112 acts as a central processing unit of the ESL and controls communication with a communication network via the interface 118 and antenna 119. The interface 118 is preferably a Bluetooth ® compliant radio module. The processor 112 accesses data in memory 114, such as software or firmware and data representing content to be displayed on the display 116. Furthermore, the processing unit 112 is configured to store and update certain data in the memory 114, including templates for displaying content. The one or more sensors 115 may comprise an optical sensor, such as an IR sensor, an acoustic sensor, such as a subsonic sensor or an ultrasound sensor, and/or a motion sensor. The sensor(s) 115 allow the ESL to detect the presence of potential customers in its immediate vicinity. The display 116 may be an electrophoretic display or an LCD display unit but is preferably an LED or OLED color display capable of displaying both text, images, and video clips to present a potential customer with relevant information on the product in the store with which it is associated. The display 116 may be one single display screen or it may contain two or more separate display sections. In the latter case, one section may e.g., constantly display some product specific information, such as product name, name of manufacturer, and price, while one or more other display sections may display varying content, such as short advertisement video clips, customer reviews, and other relevant information. In some embodiments, one display section may be reserved for displaying event related information. In case of a video screen the type of content displayed by the screen may be mixed.

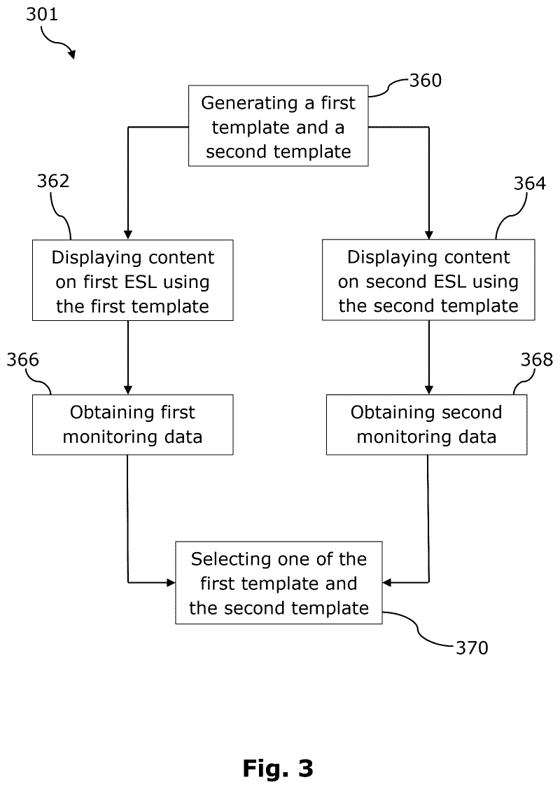

FIG. 3 shows a flow chart of a method 301 of selecting a template for displaying content on electronic display devices associated with a product for sale, the content relating to the product for sale, according to an exemplary embodiment.

The method 301 begins at block 360 by generating a first template and a second template, e.g. using the template generation unit 110 shown in FIG. 1 and discussed above. This generation involves selecting and designing a number of layout options for displaying product related content on an electronic display device or ESL, such as background color, text color, graphical design, etc. The first and second templates are preferably stored in a suitable data format that allows an electronic display device to apply it when displaying content.

At block 362, the product related content is displayed on a first electronic display device, such as ESL 121 arranged at a first location A, e.g., in a first store. Thereby, the first electronic display device 121 utilizes the first template, which has been stored in corresponding memory 114 of the first ESL 121.

Similarly, at block 364, the product related content is displayed on a second electronic display device, such as ESL 122 arranged at a second location B, e.g., in a second store. Thereby, the second electronic display device 122 utilizes the second template, which has been stored in corresponding memory 114 of the second ESL.

At block 366, first monitoring data is obtained by monitoring customer attention to and/or sale of the product at the first location A, e.g., utilizing the first monitoring arrangement 131 shown in FIG. 1 and described above. More specifically, the first monitoring data may comprise one or more of a total number of customers that pay attention to the first electronic display device 121, an amount of time that potential customers pay attention to the first electronic display device 121, the total number of products sold at the first location A, and/or sales figures or turnover of products at the first location A.

Similarly, at block 368, second monitoring data is obtained by monitoring customer attention to and/or sale of the product at the second location B, e.g., utilizing the second monitoring arrangement 132 shown in FIG. 1 and described above. More specifically, the second monitoring data may comprise one or more of a total number of customers that pay attention to the second electronic display device 122, an amount of time that potential customers pay attention to the second electronic display device 122, the total number of products sold at the second location B, and/or the sales figures or turnover of products at the second location B.

The above steps of displaying and monitoring (blocks 362, 364, 366, and 368) at the first and second locations (A and B) are preferably conducted in parallel during a predetermined period of time, such as less than an hour, an hour or a few hours, one day, one week, one month, or a longer period of time. However, they may also be conducted during different periods of time or during partially overlapping periods of time.

Then, at block 370, one of the first and second templates, i.e., either the first template or the second template, is selected based on statistical processing of the first monitoring data and the second monitoring data. Thereby, as also discussed above in conjunction with FIG. 1, the best template in terms of attention and/or sales is selected and can then be applied at both locations A and B thereafter.

Finally, it is pointed out that the figures previously described in detail are only concerned with exemplary embodiments, which can be modified in many different ways by the person skilled in the art, without departing from the scope of the invention. For the sake of completeness, it is also pointed out that the use of the indefinite article “a” or “an” does not mean that the relevant features cannot also be present multiple times.

1. A system for selecting a template for displaying content on electronic display devices associated with a product for sale, the content relating to the product for sale, the system comprising:
a template generating unit (110) configured to generate a first and a second template;
a first electronic display device (121), the first electronic display device being arranged at a first location (A) and configured to display the content utilizing the first template;
a second electronic display device (122), the second electronic display device being arranged at a second location (B) and configured to display the content utilizing the second template;
a first monitoring arrangement (131), the first monitoring arrangement being configured to monitor customer attention to and/or sales of the product at the first location and to provide corresponding first monitoring data;
a second monitoring arrangement (132), the second monitoring arrangement being configured to monitor customer attention to and/or sales of the product at the second location and to provide corresponding second monitoring data; and
a selection unit (140) configured to apply statistical processing to the first monitoring data and the second monitoring data, and to select one of the first and second templates based on the statistical processing.

2. The system according to claim 1, wherein:
the first monitoring arrangement comprises
a first video camera arranged to capture video of the first electronic display device and its surroundings; and
a first video processing device configured to receive and process the video from the first video camera, the first video processing device further configured to determine a number of potential customers that pay attention to the first electronic display device and/or an amount of time that potential customers pay attention to the first electronic display device, and/or
the second monitoring arrangement comprises
a second video camera arranged to capture video of the second electronic display device and its surroundings; and
a second video processing device configured to receive and process the video from the second video camera, the second video processing device further configured to determine a number of potential customers that pay attention to the second electronic display device and/or an amount of time that potential customers pay attention to the second electronic display device.

3. The system according to claim 1, wherein the first monitoring arrangement comprises a first sales monitoring unit coupled to a sales system at the first location and configured to determine the number of products sold and/or the sales figures or turnover of products at the first location, and/or wherein the second monitoring arrangement comprises a second sales monitoring unit coupled to a sales system at the second location and configured to determine the number of products sold and/or the sales figures or turnover of products at the second location.

4. The system according to claim 1, wherein the first monitoring arrangement comprises a first sensor configured to detect the presence of a customer within a predetermined first region in the vicinity of the first electronic display device, and/or wherein the second monitoring arrangement comprises a second sensor configured to detect the presence of a customer within a predetermined second region in the vicinity of the second electronic display device.

5. The system according to claim 1, wherein the first sensor comprises one or more sensors selected from the group consisting of an infrared sensor, a subsonic sensor, an ultrasound sensor, a radar sensor, and a motion sensor; and/or wherein the second sensor comprises one or more sensors selected from the group consisting of an infrared sensor, a subsonic sensor, an ultrasound sensor, a radar sensor, and a motion sensor.

6. The system according to claim 1, wherein:
the first monitoring data comprises one or more of: a total number of customers that pay attention to the first electronic display device, an amount of time that potential customers pay attention to the first electronic display device, the total number of products sold and/or the sales figures or turnover of products at the first location, and/or
the second monitoring data comprises one or more of: a total number of customers that pay attention to the second electronic display device, an amount of time that potential customers pay attention to the second electronic display device, the total number of products sold and/or the sales figures or turnover of products at the second location.

7. The system according to claim 1, wherein the selection unit is configured to apply the statistical processing to a part of the first monitoring data and to a part of the second monitoring data that are representative of a predetermined period of time.

8. The system according to claim 1, wherein the first electronic display device (121) is part of a first group of electronic display devices (ESL) connected to a first controller (151) at the first location (A), and wherein the second electronic display device (122) is part of a second group of electronic display devices (ESL) connected to a second controller (152) at the second location (B).

9. The system according to claim 1, wherein the first controller, the second controller, the template generating unit, and the selection unit are interconnected through a communication network.

10. The system according to claim 1, further comprising a server, said server comprising the template generating unit and the selection unit.

11. The system according to claim 1, claims, wherein the selection unit is configured to, based on the statistical processing, automatically select the one of the first template and the second template that provide the better performance in terms of sales and/or customer attention.

12. The system according to claim 1, wherein the first electronic display device and the second electronic display device are configured to apply the one of the first template and second template that is selected by the selection unit.

13. The system according to claim 1, wherein the template generating unit is further configured to generate a third and a fourth template, the system further comprising:
a third electronic display device, the third electronic display device being arranged at a third location and configured to display the content utilizing the third template;
a fourth electronic display device, the fourth electronic display device being arranged at a fourth location and configured to display the content utilizing the fourth template;
a third monitoring arrangement, the third monitoring arrangement being configured to monitor customer attention to and/or sales of the product at the third location and to provide corresponding third monitoring data;
a fourth monitoring arrangement, the fourth monitoring arrangement being configured to monitor customer attention to and/or sales of the product at the fourth location and to provide corresponding fourth monitoring data,
wherein the selection unit is configured to apply statistical processing to the third monitoring data and the fourth monitoring data, and to further select one of the third and fourth templates based on the statistical processing, and
wherein the first and second locations are located in a first region and the third and fourth locations are located in a second region.

14. A method (301) of selecting a template for displaying content on electronic display devices associated with a product for sale, the content relating to the product for sale, the method comprising:
generating (360) a first template and a second template;
displaying (362) the content on a first electronic display device arranged at a first location, the first electronic display device utilizing the first template;
displaying (364) the content on a second electronic display device arranged at a second location, the second electronic display device utilizing the second template;
obtaining (366) first monitoring data by monitoring customer attention to and/or sale of the product at the first location;
obtaining (368) second monitoring data by monitoring customer attention to and/or sale of the product at the second location; and
selecting (370) one of the first and second templates based on statistical processing of the first monitoring data and the second monitoring data.

15. The method according to claim 14, wherein:
the first monitoring data comprises one or more of: a total number of customers that pay attention to the first electronic display device, an amount of time that potential customers pay attention to the first electronic display device, the total number of products sold at the first location, and/or sales figures or turnover of products at the first location, and/or
the second monitoring data comprises one or more of: a total number of customers that pay attention to the second electronic display device, an amount of time that potential customers pay attention to the second electronic display device, the total number of products sold at the second location, and/or the sales figures or turnover of products at the second location.

16. The method according to claim 14, wherein the statistical processing is applied to a part of the first monitoring data and to a part of the second monitoring data that are representative of a predetermined period of time.

17. The method according to claim 14, wherein selecting one of the first and second templates comprises automatically selecting the one of the first template and the second template that provide the better performance in terms of sales and/or customer attention.

18. The method according to claim 14, further comprising:
generating a third template and a fourth template;
displaying the content on a third electronic display device arranged at a third location, the third electronic display device utilizing the third template;
displaying the content on a fourth electronic display device arranged at a fourth location, the fourth electronic display device utilizing the fourth template;
obtaining third monitoring data by monitoring customer attention to and/or sale of the product at the third location;
obtaining fourth monitoring data by monitoring customer attention to and/or sale of the product at the fourth location; and
selecting one of the third and fourth templates based on statistical processing of the third monitoring data and the fourth monitoring data,
wherein the first and second locations are located in a first region and the third and fourth locations are located in a second region.
